(19) United States
(12) Patent Application Publication
(10) Pub. No.: US 2004/0048676 A1
(43) Pub. Date: Mar. 11, 2004

(54) Rolling bearing ring of constant velocity joint, and support component for rolling and swinging motion

(75) Inventor: Yukio Fujii, Kuwana-shi (JP)

Correspondence Address: MCDERMOTT, WILL & EMERY, 600 13th Street, N.W., WASHINGTON, DC, 20005-3096, US

(73) Assignee: NTN CORPORATION

(21) Appl. No.: 10/653,199

(22) Filed: Sep. 3, 2003

(30) Foreign Application Priority Data
Sep. 5, 2002 (JP) 2002-260284(P)

(51) Int. Cl. F16D 3/26

(52) U.S. Cl. 464/111; 464/145

(57) ABSTRACT

A rolling bearing ring of a constant velocity joint employs steel of a component composition containing at least, as alloying elements, at least 0.5 mass % and 0.7 mass % at most of carbon, at least 0.5 mass % and 1.0 mass % at most of silicon, and at least 0.5 mass % and 1.0 mass % at most of manganese with the remainder including iron and inevitable impurities. The rolling bearing ring has a structure with the raceway surface subjected to induction hardening. A rolling bearing ring of a constant velocity joint and a support component for rolling and swinging motion are obtained, improved in the lifetime with respect to the rolling and swinging motion involving sliding at the raceway surface subjected to induction hardening, and suppressed in cost to a level equal to that of a conventional product.

### BACKGROUND OF THE INVENTION

1. Field of the Invention

The present invention relates to a rolling bearing ring of a constant velocity joint fabricated by induction hardening, and a support component for rolling and swinging motion.

2. Description of the Background Art

When a constant velocity joint transmits torque with an operating angle, the steel ball rolls and slides on a raceway surface of the rolling bearing ring to exhibit a swinging motion. For the rolling bearing ring of a constant velocity joint that has the raceway surface subjected to induction hardening, S53C that is medium carbon steel is conventionally employed as the main material. In view of the relatively light load condition as well as the sophisticated configuration of the components for usage applications, material choice was conducted based on workability and low cost. However, in accordance with the strive to save energy, the higher contact pressure due to reduction in size, and the severe usage environment, the demand for a material with increased lifetime with respect to the rolling and swinging motion involving sliding is now growing.

Examples of constant velocity joints are disclosed in, for example, Japanese Patent Laying-Open No. 55-76219, Japanese Utility Model Publication No. 63-2665, and Japanese Patent Laying-Open No. 62-233522.

In accordance with the trend to save energy and reduce the size, the rolling bearing ring of a constant velocity joint is now used under further severe conditions. The need arises for a new product that exhibits longer lifetime with respect to rolling and swinging motion involving sliding.

### SUMMARY OF THE INVENTION

An object of the present invention is to provide a rolling bearing ring of a constant velocity joint and a support component for rolling and swinging motion improved in the lifetime with respect to rolling and swinging motion involving sliding at the raceway surface subjected to induction hardening while keeping the cost to a level equal to that of a conventional product.

According to an aspect of the present invention, a rolling bearing ring of a constant velocity joint of the present invention employs steel of a component composition containing at least, as alloying elements, at least 0.5 mass % and 0.7 mass % at most of carbon, at least 0.5 mass % and 1.0 mass % at most of silicon, and at least 0.5 mass % and 1.0 mass % at most of manganese with the remainder including iron and inevitable impurities. The rolling bearing ring of the constant velocity joint has a structure with the raceway surface subjected to induction hardening.

The inventor made every endeavor to find out that the lifetime with respect to the rolling and swinging motion involving sliding at the raceway surface subjected to induction hardening can be improved while preventing a rise in the cost by employing the above component composition. Accordingly, a rolling bearing ring of a constant velocity joint improved in the lifetime with respect to the rolling and swinging motion involving sliding at the raceway surface subjected to induction hardening while keeping the cost to a level equal to that of a conventional product can be obtained.

The reason why the amount of carbon is set to at least 0.5 mass % and 0.7 mass % at most is set forth below. The required amount of carbon to ensure hardness of at least a predetermined level by induction hardening is at least 0.5 mass %. Therefore, this value is taken as the lower limit. It is noted that carbon forms carbide and an abundant amount is preferable in order to achieve stable hardness. However, an excessive amount will increase the hardness of the base material to degrade workability. Also, certain heat treatment such as high temperature diffusion heat treatment (soaking) to prevent segregation of the component, carbide spheroidizing or the like will be required if a large amount of carbon is contained. This will lead to a rise in costs. Therefore, 0.7 mass % is set as the upper limit.

The reason why the amount of silicon is set to at least 0.5 mass % and 1.0 mass % at most is set forth below. Silicon is an element reinforcing the matrix. Silicon functions to suppress softening when subjected to high temperature and to suppress structual change and crack generation caused by repetitive application of a great load. These functions are significant with the lower limit set to 0.5 mass %. Increasing the amount of silicon will not contribute to increasing the hardness of the base material as compared to manganese described afterwards, and an excessive amount will impede cold-working and hot-working. Therefore, the upper limit is set to 1.0 mass %.

The reason why the amount of manganese is set to at least 0.5 mass % and 1.0 mass % at most is set forth below. Manganese functions to improve the quenching property of steel. Also, manganese enters into solid solution in steel to develop strength in steel and to increase retained austenite favorable for rolling contact fatigue. Manganese functions to strengthen the matrix likewise silicon, and also permeates into the carbide to increase the hardness thereof. Accordingly, manganese is effective in increasing the hardness of the matrix. Thus, the workability and machinability will be degraded if too much manganese is added. In view of the foregoing, the lower limit and the upper limit are set to 0.5 mass % and 1.0 mass %, respectively, as to the containing amount of manganese.

Preferably in the rolling bearing ring of the constant velocity joint of the present invention, steel is employed having a component composition satisfying the relationship of L≧50 in the equation of:

L=105.4×(C%)^{-0.84}×(Si%)^{1.18}×(Mn%)^{1.24}

where C%, Si% and Mn% represent the percentage content (mass %) of carbon, silicon, and manganese, respectively.

Thus, by identifying the amount of the alloying elements of C, Si and Mn, L₅₀ can be estimated accurately in accordance with the above equation. By an alloy component composition whose value of L₅₀ obtained from the above equation is 50 hours or above, the lifetime with respect to the rolling and swinging motion involving sliding at the raceway surface subjected to induction hardening can be improved while preventing a rise in costs.

A support component for rolling and swinging motion of the present invention includes the above-described rolling bearing ring of the constant velocity joint.

By incorporating a rolling bearing ring of the constant velocity joint of the present invention, a support component for rolling and swinging motion improved in the lifetime with respect to the rolling and swinging motion involving sliding at the raceway surface subjected to induction hardening can be obtained while preventing a rise in costs.

The foregoing and other objects, features, aspects and advantages of the present invention will become more apparent from the following detailed description of the present invention when taken in conjunction with the involving drawings.

### BRIEF DESCRIPTION OF THE DRAWINGS

FIG. 1 is a partial sectional view of a structure of a rigid joint identified as a constant velocity joint according to an embodiment of the present invention, taken along line I-I of FIG. 2.

FIG. 2 is a schematic sectional view of the rigid joint of FIG. 1 taken along line II-II.

FIG. 3 is a schematic sectional view of the rigid joint of FIG. 1 in an angled state.

FIG. 4 is a partial sectional view of a structure of a double offset joint identified as a constant velocity joint according to an embodiment of the present invention.

FIG. 5 is a partial sectional view of a structure of a triport joint identified as a constant velocity joint according to an embodiment of the present invention.

FIG. 6 is a schematic sectional view of the triport joint of FIG. 5 taken along line VI-VI.

FIG. 7 is a schematic sectional view of the triport joint of FIG. 5 in an angled state.

FIGS. 8A and 8B are schematic diagrams of the basic portion of a reciprocation rolling and sliding tester.

FIG. 9 represents the relationship between actual measurement values and estimated values of the lifetime in a reciprocation rolling and sliding test.

### DESCRIPTION OF THE PREFERRED EMBODIMENTS

Embodiments of the present invention will be described hereinafter with reference to the drawings.

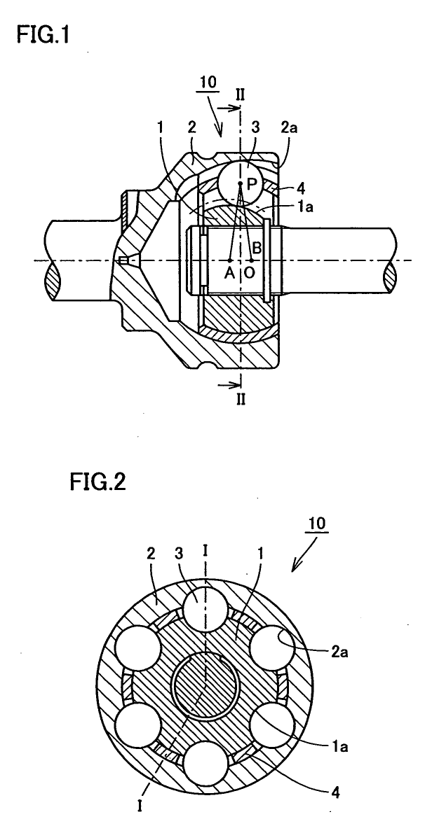

Referring to FIGS. 1-3, a rigid joint 10 of the present invention includes an inner ring 1 and an outer ring 2 corresponding to two shafts, a torque transmitting ball 3 located between inner and outer rings 1 and 2, and a ball cage 4 retaining ball 3. Ball 3 is fitted into ball grooves 1a and 2a arranged equally with respect to each other at the other circumferential plane of inner ring 1 and the inner circumferential plane of outer ring 2.

The outer circumferential plane of inner ring 1 and inner circumferential plane of outer ring 2 each correspond to a curve with a center of curvature at respective points A and B located at equal distance from the joint center O in the left and right side as shown in FIG. 1. Namely, the trajectory of the midpoint of ball 3 rolling along ball groove 1a and 2a corresponds to a curve with the center of curvature at points A and B. Accordingly, ball 3 is always oriented on the bisector of the angle between the two shafts, ensuring constant velocity at any operating angle and any angle of rotation.

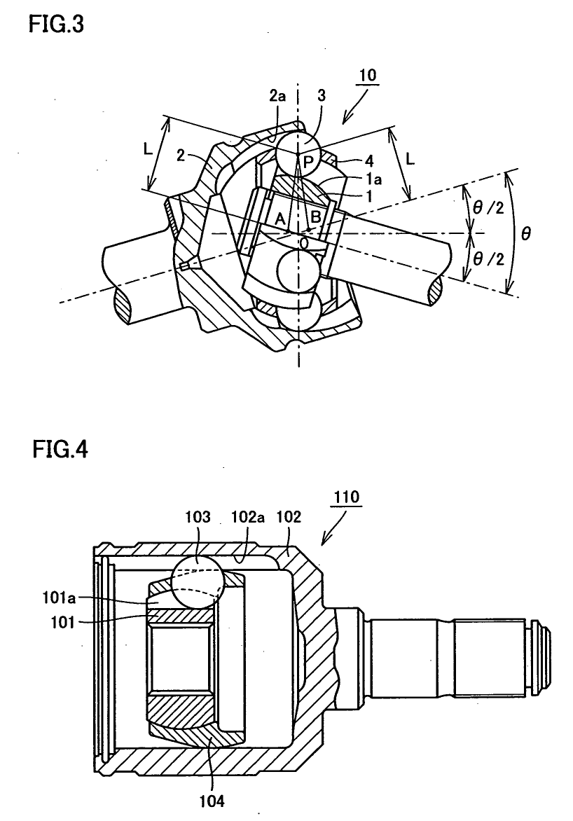

As to the constant velocity property of this type of constant velocity joint 10, ball 3 transmitting torque always positioned on the bisector of the angle between the two shafts is set as the necessary and sufficient condition. Thus, when the two shafts take the angle of θ as shown in FIG. 3, the mutual guidance between the spherical inner circumferential plane of outer ring 2 and the spherical outer circumferential plane of ball cage 4 and between the spherical inner circumferential plane of ball cage 4 and the spherical outer circumferential plane of inner ring 1 causes joint 10 to be angled about the center O of these spheres. In this state, ball 3 is guided through ball grooves 2a and 1a of outer ring 2 and inner ring 1, respectively, centered at a position shifted from point O to move onto the bisector of the angle between the two shafts.

In this context, ball cage 4 serves to receive, together with the spherical inner circumferential plane of outer ring 2 and the spherical outer circumferential plane of inner ring 1, the force exerted on ball 3 to jump out from ball grooves 1a and 2a when torque is transmitted to ensure ball 3 in place, in addition to determining the center of joint 10 when angled. The distance from the center O of joint 10 to center B of ball groove 2a of outer ring 2 is set equal to the distance from the center O of joint 10 to center A of ball groove 1a of inner ring 1. Therefore, the distance from center P of ball 3 to point A and the distance from center P to point B are equal. ΔOAP and ΔOBP are congruent with each other since their three sides are equal to each other. Accordingly, the distance L from the two shafts to center P of ball 3 is equal, and ball 3 is located on the bisector of the angle between the two shafts. Thus, the constant velocity property is ensured.

In such a rigid joint 10 that is one type of constant velocity joint, at least one of inner ring 1 and outer ring 2 identified as the rolling bearing ring employs steel of a component composition containing at least, as alloying elements, at least 0.5 mass % and 0.7 mass % at most of carbon, at least 0.5 mass % and 1.0 mass % at most of silicon, and at least 0.5 mass % and 1.0 mass % at most of manganese with the remainder including iron and inevitable impurities. Also, at least one of inner and outer rings 1 and 2 has a structure in which the raceway surface is subjected to induction hardening.

Also, at least one of inner and outer rings 1 and 2 identified as the rolling bearing ring preferably employs steel of a component composition satisfying the relationship of L≧50 in the equation of:

L=105.4×(C%)^{-0.84}×(Si%)^{1.18}×(Mn%)^{1.24}

where C%, Si% and Mn% are the percentage contents of carbon, silicon and manganese, respectively.

The above description is based on a rigid joint as one type of a constant velocity joint. A double offset joint, or a triport joint may also be employed as the constant velocity joint of the present invention. Each of these constant velocity joints will be described hereinafter.

Referring to FIG. 4, a double offset joint 110 includes a hollow outer member 102 having a cylindrical inner surface corresponding to a linear guide groove 102a, an inner member 101 with an outer surface corresponding to a groove 101a forming a ball track in cooperation with guide groove 102a of outer member 102, a torque transmitting ball 103 arranged in each of grooves 101a and 102a, and a cage 104 with a ball pocket in which torque transmitting ball 103 is accommodated.

Torque transmitting ball 103 is guided by the cylindrical inner surface of outer member 102 and the partial spherical outer surface of inner member 101. The outer surface of inner member 101 with a partial spherical outer surface having the center of curvature shifted equally in the left and right sides about the ball center line on the joint shaft is formed to have a radius equal to the radius of the inner surface of cage 104. The outer surface of inner member 101 and the inner surface of cage 104 are brought into spherical contact, wherein ball 103 is accommodated in the ball pocket of cage 104 with an appropriate margin.

Similarly in this double offset joint 110, at least one of inner member 101 and outer member 102 of the rolling bearing ring employs steel of a component composition containing at least, as alloying elements, at least 0.5 mass % and 0.7 mass % at most of carbon, at least 0.5 mass % and 1.0 mass % at most of silicon, and at least 0.5 mass % and 1.0 mass % at most of manganese with the remainder including iron and inevitable impurities. Also, at least one of inner and outer members 101 and 102 has a structure in which the raceway surface is subjected to induction hardening.

Also, at least one of inner and outer members 101 and 102 identified as the rolling bearing ring preferably employs steel of a component composition satisfying the relationship of L≧50 in the equation of:

L=105.4×(C%)^{-0.84}×(Si%)^{1.18}×(Mn%)^{1.24}

where C%, Si% and Mn% are the percentage contents of carbon, silicon and manganese, respectively.

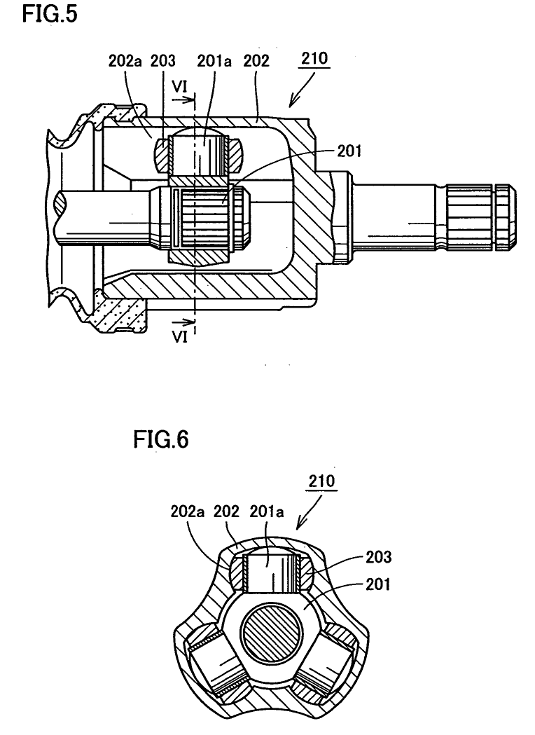

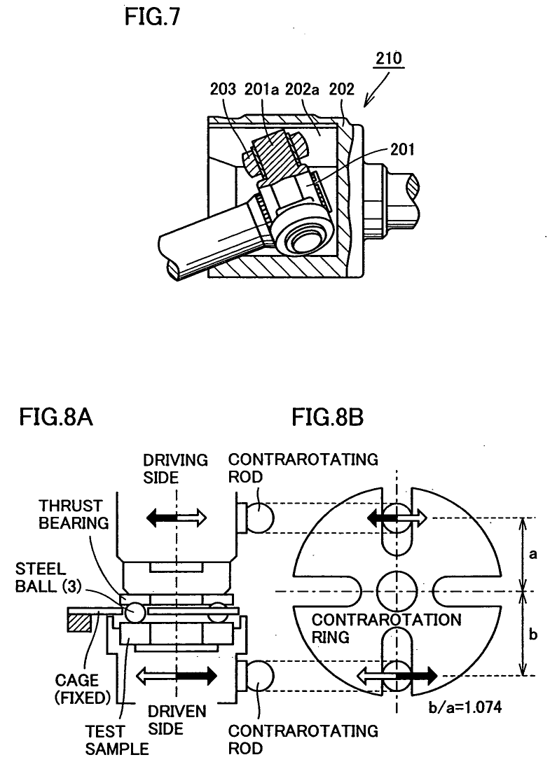

Referring to FIGS. 5-7, a triport joint 210 includes an outer ring 202 having three cylindrical track grooves 202a in the direction of the axis as the inner plane, a triport member 201 arranged inner to outer ring 202, a leg shaft 201a protruding at the radial outer circumferential side of triport member 201, and a spherical roller 203 attached rotatably at the outer side of each leg shaft 201a. Spherical roller 203 engages with the roller guide plane at both sides of cylindrical track groove 202a so as to slide axially.

In such a triport joint 210 that is one type of constant velocity joint, outer ring 202 identified as the rolling bearing ring employs steel of a component composition containing at least, as alloying elements, at least 0.5 mass % and 0.7 mass % at most of carbon, at least 0.5 mass % and 1.0 mass % at most of silicon, and at least 0.5 mass % and 1.0 mass % at most of manganese with the remainder including iron and inevitable impurities, and has a structure in which the raceway surface is subjected to induction hardening.

Also, outer ring 202 identified as the rolling bearing ring preferably employs steel of a component composition satisfying the relationship of L≧50 in the equation of:

L=105.4×(C%)^{-0.84}×(Si%)^{1.18}×(Mn%)^{1.24}

where C%, Si% and Mn% are the percentage contents of carbon, silicon and manganese, respectively.

The present invention is widely applicable to a support component of rolling and swinging motion with a rolling bearing ring of the above-described constant velocity joint.

Examples of the present invention will be described hereinafter.

With the base material of steel, shown in Table 1, having the alloy components of A1-A5 as examples of the present invention and the alloy components of B1-B8 outside the range of the present invention as comparative examples, reciprocation rolling and sliding test samples subjected to induction hardening (a hardened layer having a hardness of at least HRC59 is formed to the depth of approximately 2 mm from the surface) were produced. As indicated in the Note column of Table 1, Comparative Example B1 is S53C, which is conventional steel.

TABLE 1
Basic Alloy Component of Test Steel

| | | Alloy Component (mass %) | | | |
|---|---|---|---|---|---|
| Type | No. | C | Si | Mn | Note |
| Example of | A1 | 0.56 | 0.82 | 0.83 | |
| Present | A2 | 0.60 | 0.80 | 0.60 | |
| Invention | A3 | 0.59 | 0.50 | 0.82 | |
| | A4 | 0.60 | 0.98 | 0.82 | |
| | A5 | 0.58 | 0.51 | 0.82 | |
| Comparative | B1 | 0.55 | 0.22 | 0.88 | S53C |
| Example | B2 | 0.53 | 1.00 | 0.25 | |
| | B3 | 0.53 | 0.61 | 0.49 | |
| | B4 | 0.53 | 0.38 | 0.25 | |
| | B5 | 0.55 | 0.25 | 1.21 | |
| | B6 | 0.76 | 0.55 | 0.36 | |
| | B7 | 0.47 | 0.55 | 0.29 | |
| | B8 | 0.65 | 1.13 | 0.26 | |

The ten types of steel of the above Table 1 were evaluated by a reciprocation rolling and sliding test simulating the movement of a constant velocity joint.

Referring to FIGS. 8A and 8B, three steel balls (⅜″) are arranged equally with respect to each other between a test sample and a thrust bearing (number of bearing under JIS: 51305) by means of a cage. As the upper portion (thrust bearing side) is driven to swing, that motion is conveyed to the contrarotation ring via the upper contrarotating rod. The motion of that contrarotation ring is transmitted to the lower portion (test sample side) via the lower contrarotating rod. The lower portion swings in a direction opposite to that of the upper portion. Since the position relationship between the contrarotation ring and the upper and lower contrarotating rods is b>a, the swinging span of the lower portion becomes greater than the swinging span of the upper portion, as represented by the length of the arrow in the drawing. The cage is fixed, and there is a slight gap between the steel ball and the cage pocket. When the ball slides on the test sample, the ball exhibits absolute rolling in the proximity of the center of the swing, involving sliding at either side end of the stroke by the interference between the steel ball and the cage.

The following Table 2 represents the conditions of the reciprocation rolling and sliding test. The slip ratio in Table 2 is the average value obtained from the difference between the upper and lower swing lengths.

TABLE 2
Reciprocation Rolling and Sliding Test Condition

| Swing rate | | 500 | cpm |
|---|---|---|---|
| Maximum contact pressure | | 3.5 | GPa |
| Lubricant | | VG10 | |
| Slip ratio | | 7.4% | |
| Surface | Test sample | 0.033 | μm |
| Roughness | Steel ball (of SUJ2) | 0.27 | μm |
| Ra | | | |

Detection of flaking failure was conducted through an intermittent movement. Following a running-in period of 20 hours, occurrence of flaking failure was examined. Upon confirming that there is no flaking failure, the steel ball was exchanged to a new one. Then, testing was conducted for 5 hours, and occurrence of flaking failure was examined. This 5-hour period testing was repeated until flaking failure occurred. The end of the lifetime was identified at the time point of flaking failure. The number of test samples for each material was at least six (N=6). The lifetime was evaluated in terms of L50 life. The results of the reciprocation rolling and sliding test are shown in the following Table 3.

TABLE 3
Results of Reciprocation Rolling and Sliding Test

L₅₀(h)

| | | Actual | | |
|---|---|---|---|---|
| | | Measurement | Estimated | |
| Type | No. | Value | Value | Note |
| Example of | A1 | 108.8 | 107.7 | |
| Present | A2 | 56.0 | 66.0 | |
| Invention | A3 | 56.2 | 56.6 | |
| | A4 | 129.8 | 123.6 | |
| | A5 | 55.5 | 58.8 | |
| Comparative | B1 | 39.4 | 24.9 | S53C |
| Example | B2 | 37.1 | 32.2 | |
| | B3 | 28.5 | 41.4 | |
| | B4 | 23.8 | 10.3 | |
| | B5 | 37.5 | 43.0 | |
| | B6 | 23.7 | 18.5 | |
| | B7 | 27.1 | 21.1 | |
| | B8 | 29.6 | 32.9 | |

The estimated value L₅₀ in Table 3 is obtained by conducting a regression analysis with actual measurement value L₅₀ as the target variate and the amount of alloying elements C, Si and Mn as the dependent variates, using the following equation (1).

L₅₀=105.4×(C%)^{-0.84}×(Si%)^{1.18}×(Mn%)^{1.24} (1)

In the above equation, C%, Si% and Mn% represent the percentage content (mass %) of alloying elements C, Si and Mn, respectively.

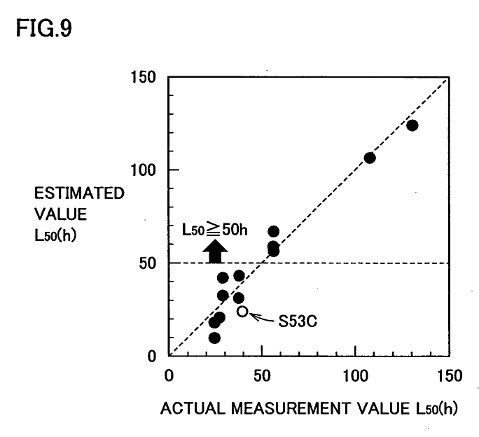

It is appreciated from the results of Table 3 and the graph of FIG. 9 that there is favorable correlation between actual measurement value L₅₀ and estimated value L₅₀. It is to be noted that the actual measurement value L₅₀ was 39.4 hours whereas the estimated value of L₅₀ was 23.9 hours for S53C (Comparative Example B1). In view of the structure based only on economic alloying elements C, Si and Mn, it is desirable to achieve L₅₀ of 50 hours that is at least two times the estimated value L₅₀ of S53C. The L₅₀ values of developed steel A1-A5 exceeded 50 hours for both the actual measurement values and estimated values. Since L₅₀ can be estimated accurately by equation (1) if the amount of alloying elements C, Si and Mn are known, any composition, in addition to the aforementioned alloy component composition of the present invention, that has at least 50 hours for the value of L₅₀ obtained by equation (1) can satisfy the above requirement.

By employing steel having the containing amount of economic C, Si and Mn optimized for the rolling bearing ring of the constant velocity joint and the support component for rolling and swinging motion of the present invention, the lifetime with respect to the rolling and swinging motion involving sliding at the raceway surface subjected to induction hardening can be improved, and the cost can be kept to a level equal to that of a conventional product of S53C.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A rolling bearing ring of a constant velocity joint, employing steel of a component composition containing at least, as alloying elements, at least 0.5 mass % and 0.7 mass % at most of carbon, at least 0.5 mass % and 1.0 mass % at most of silicon, and at least 0.5 mass % and 1.0 mass % at most of manganese with a remainder including iron and inevitable impurities, and having a structure in which a raceway surface is subjected to induction hardening.

2. The rolling bearing ring of a constant velocity joint according to claim 1, wherein steel is employed having a component composition satisfying L≧50 in an equation of:
L=105.4×(C%)^{-0.84}×(Si%)^{1.18}×(Mn%)^{1.24}
where C%, Si% and Mn% are a percentage content (mass %) of carbon, silicon and manganese, respectively.

3. A support component of rolling and swinging motion, comprising the rolling bearing ring of a constant velocity joint defined in claim 1.
